(19) United States
(12) Patent Application Publication
(10) Pub. No.: US 2024/0393213 A1
(43) Pub. Date: Nov. 28, 2024

(54) PREDICTION METHOD FOR DURABILITY OF TIRE

(71) Applicant: Sumitomo Rubber Industries, Ltd., Hyogo (JP)

(72) Inventors: Yuki HARADA, Kobe-shi (JP); Yoshiki KANAYA, Kobe-shi (JP); Hiroki SARASHI, Kobe-shi (JP); Eiji YOSHIOKA, Kobe-shi (JP)

(73) Assignee: Sumitomo Rubber Industries, Ltd., Hyogo (JP)

(21) Appl. No.: 18/663,155

(22) Filed: May 14, 2024

(30) Foreign Application Priority Data
May 25, 2023 (JP) 2023-085890

(51) Int. Cl. G01M 17/02; G06T 7/593

(52) U.S. Cl. CPC G01M 17/027; G06T 7/593; G06T 2207/30204

(57) ABSTRACT

A prediction method includes: measuring an actual shape of a rolling reference tire; acquiring a displacement profile as a change in the actual shape due to rolling; calculating displacement amounts of order components of first to Nth orders (N is an integer of 2 or more) in the displacement profile through fast Fourier transform; obtaining, as a quantitative index value, a reciprocal of a sum of displacement amounts of order components reflecting a change in the actual shape due to a sign of the standing wave phenomenon, and acquiring a correlation between a performance index value representing durability of the reference tire and the quantitative index value; and simulating rolling of the reference tire to estimate a virtual quantitative index value corresponding to the quantitative index value, and acquiring a correlation between the virtual quantitative index value and the quantitative index value.

### BACKGROUND OF THE INVENTION

### Field of the Invention

The present invention relates to a prediction method for the durability of a tire. Specifically, the present invention relates to a method for predicting the durability of a tire in consideration of a standing wave phenomenon.

### BACKGROUND ART

In many cases, the evaluation of the durability of a tire involves destruction of the tire (e.g., Japanese Laid-Open Patent Publication No. 2019-078646). Establishment of a technology capable of evaluating the durability of a tire without involving destruction of the tire is required.

An object of the present invention is to provide a prediction method for the durability of a tire, which allows the durability of a tire for which prediction is to be performed without destroying the tire.

### SUMMARY OF THE INVENTION

A prediction method for the durability of a tire according to the present invention is a method for predicting durability of a tire in consideration of a standing wave phenomenon. The prediction method includes: measuring an actual shape of a reference tire rolling on a road surface; acquiring a displacement profile represented by a difference between an actual shape of the rolling reference tire and an actual shape of the stopped reference tire, as a change in the actual shape due to rolling; calculating displacement amounts of order components of first to Nth orders (N is an integer of 2 or more) in the displacement profile through fast Fourier transform; obtaining, as a quantitative index value, a reciprocal of a sum of displacement amounts of order components reflecting a change in the actual shape due to a sign of the standing wave phenomenon, and acquiring a correlation between a performance index value representing durability of the reference tire and the quantitative index value; and simulating rolling of the reference tire to estimate a virtual quantitative index value corresponding to the quantitative index value, and acquiring a correlation between the virtual quantitative index value and the quantitative index value. In measuring the actual shape of the reference tire, a speed of the reference tire is increased stepwise by repeating a step of setting the speed of the reference tire to a predetermined speed and causing the reference tire to run for a predetermined time.

According to the present invention, a prediction method for the durability of a tire, which allows the durability of a tire for which prediction is to be performed without destroying the tire, is obtained.

### BRIEF DESCRIPTION OF THE DRAWINGS

FIG. 1 is a schematic diagram illustrating a standing wave phenomenon;

FIG. 2 is a schematic plan view showing an outline of a test apparatus used in a prediction method for the durability of a tire according to one embodiment of the present invention;

FIG. 3 is a perspective view showing a part of the test apparatus in FIG. 2;

FIG. 4 is a conceptual diagram showing an example of a control part;

FIG. 5 is a flowchart showing an outline of the prediction method for the durability of a tire according to the one embodiment of the present invention;

FIG. 6 is a graph showing an image of a speed profile of a tire executed in the prediction method;

FIG. 7 shows an example of the measurement results of the actual shape of a rolling tire;

FIG. 8 is a graph showing a displacement profile representing a change in the actual shape due to rolling;

FIG. 9 is a graph showing an image of a displacement profile of a first-order component acquired by performing fast Fourier transform on the displacement profile;

FIG. 10 is a graph showing the displacement amount of each order component acquired by performing fast Fourier transform on the displacement profile;

FIG. 11 is a graph showing the displacement amount of each order component acquired by performing fast Fourier transform on the displacement profile;

FIG. 12 is a graph showing a correlation between a quantitative index value and a performance index value;

FIG. 13 is a graph showing the displacement amount of each order component acquired by performing fast Fourier transform on each displacement profile estimated through simulation;

FIG. 14 is a graph showing a correlation between a virtual quantitative index value and the performance index value; and

FIG. 15 is a graph showing a correlation between the virtual quantitative index value and the quantitative index value.

### DETAILED DESCRIPTION

In the present invention, a state where a tire is fitted on a standardized rim, the internal pressure of the tire is adjusted to a standardized internal pressure, and no load is applied to the tire is referred to as standardized state.

The standardized rim means a rim specified in a standard on which the tire is based. The “standard rim” in the JATMA standard, the “Design Rim” in the TRA standard, and the “Measuring Rim” in the ETRTO standard are standardized rims.

The standardized internal pressure means an internal pressure specified in the standard on which the tire is based. The “highest air pressure” in the JATMA standard, the “maximum value” recited in the “TIRE LOAD LIMITS AT VARIOUS COLD INFLATION PRESSURES” in the TRA standard, and the “INFLATION PRESSURE” in the ETRTO standard are standardized internal pressures.

A standardized load means a load specified in the standard on which the tire is based. The “maximum load capacity” in the JATMA standard, the “maximum value” recited in the “TIRE LOAD LIMITS AT VARIOUS COLD INFLATION PRESSURES” in the TRA standard, and the “LOAD CAPACITY” in the ETRTO standard are standardized loads.

In the present invention, a speed symbol is, for example, a symbol that is defined in the JATMA standard and represents a highest speed at which the tire can run in a state where a mass indicated by a load index of the tire is applied to the tire under specified conditions.

In the present invention, the load index (LI) is, for example, an index that is defined in the JATMA standard and represents a maximum mass allowed to be applied to the tire under specified conditions, that is, a maximum load capacity, as an index number.

In the present invention, a tread portion of the tire is a portion of the tire that comes into contact with a road surface. A bead portion is a portion of the tire that is fitted to a rim. A sidewall portion is a portion of the tire that extends between the tread portion and the bead portion. The tire includes a tread portion, a pair of bead portions, and a pair of sidewall portions as portions thereof. A boundary portion between the tread portion and each sidewall portion is also referred to as buttress.

### Findings on Which Present Invention is Based

One of the evaluation items for the durability of tires is high-speed durability. In the evaluation of high-speed durability, a tire is caused to run, while the speed thereof is increased stepwise, until the tire bursts. The high-speed durability of the tire is evaluated with the speed at which the tire bursts and the running time taken until the tire bursts, which are obtained from this running test.

In order to evaluate the durability of tires, tires are needed. Evaluation tires are produced for performing the evaluation. A running test is performed on the produced tires. The tire evaluation is time-consuming. A tire development period tends to be long.

The evaluation of high-speed durability involves destruction of a tire. Since the tire runs at high speed, the impact generated when the tire bursts is strong. A test apparatus may be broken down by flying debris of the tire.

Due to such circumstances, establishment of a technology capable of evaluating the durability of a tire without involving destruction of the tire is required.

Meanwhile, a standing wave phenomenon is known as one of the phenomena that occur in a running tire. The standing wave phenomenon is a phenomenon that occurs when a tire runs at high speed in a state where the air pressure thereof is insufficient.

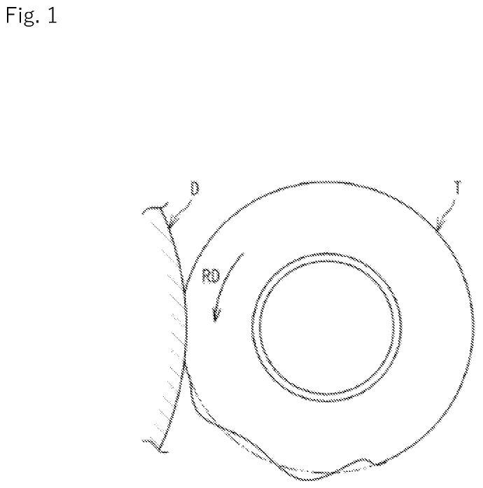

FIG. 1 is a schematic diagram showing a state where a standing wave phenomenon occurs in a tire T running on a drum D. In FIG. 1, a direction indicated by an arrow RD is the rotation direction of the tire T.

As shown in FIG. 1, the tire T is deformed into a wavy shape when the standing wave phenomenon occurs. If the running continues in this state, the tire T heats up and eventually bursts. The standing wave phenomenon affects the durability of the tire T.

The present inventors have conducted an intensive study focusing on the fact that the tire T is deformed into a wavy shape when the standing wave phenomenon occurs. As a result, the present inventors have found that a sign of the standing wave phenomenon can be captured by acquiring the deformation of the tire T due to running as a displacement profile, this sign can be grasped as a displacement amount by analyzing the displacement profile representing this sign through fast Fourier transform, this displacement amount is correlated with an index value of durability obtained using the tire T, and this displacement amount can be estimated through simulation, thereby leading to completion of the present invention described below.

### Outline of Embodiments of Present Invention

### Configuration 1

A prediction method for the durability of a tire according to an aspect of the present invention is a method for predicting durability of a tire in consideration of a standing wave phenomenon, including: measuring an actual shape of a reference tire rolling on a road surface; acquiring a displacement profile represented by a difference between an actual shape of the rolling reference tire and an actual shape of the stopped reference tire, as a change in the actual shape due to rolling; calculating displacement amounts of order components of first to Nth orders (N is an integer of 2 or more) in the displacement profile through fast Fourier transform; obtaining, as a quantitative index value, a reciprocal of a sum of displacement amounts of order components reflecting a change in the actual shape due to a sign of the standing wave phenomenon, and acquiring a correlation between a performance index value representing durability of the reference tire and the quantitative index value; and simulating rolling of the reference tire to estimate a virtual quantitative index value corresponding to the quantitative index value, and acquiring a correlation between the virtual quantitative index value and the quantitative index value, wherein, in measuring the actual shape of the reference tire, a speed of the reference tire is increased stepwise by repeating a step of setting the speed of the reference tire to a predetermined speed and causing the reference tire to run for a predetermined time.

With the prediction method thus designed for durability of a tire, the speed at which a tire bursts and the running time until the tire bursts can be predicted, for example, by calculating strain generated in the tire due to running. The prediction method allows the durability of a tire for which prediction is to be performed without destroying the tire.

### Configuration 2

Preferably, in the prediction method for the durability of a tire described in [Configuration 1] above, the time for which the reference tire runs at the set speed in one such step is not shorter than 30 seconds and not longer than 60 minutes, and a difference between the set speed of the reference tire in a step next to one such step and the set speed of the reference tire in the one such step is not less than 5 km/h and not greater than 10 km/h.

### Configuration 3

Preferably, in the prediction method for the durability of a tire described in [Configuration 1] or [Configuration 2] above, the step is repeated until the running of the reference tire can no longer be maintained.

### Configuration 4

Preferably, in the prediction method for the durability of a tire described in any one of [Configuration 1] to [Configuration 3] above, the quantitative index value is obtained in a displacement profile including an order component having a peak in order components from 10th to 15th-order components in a relationship between the order component and the displacement amount.

### Configuration 5

Preferably, in the prediction method for the durability of a tire described in

[Configuration 4] above, the quantitative index value is represented as a reciprocal of a sum of displacement amounts of order components in a range of ±7 order components centered on the order component having a peak.

### Details of Embodiments of Present Invention

Hereinafter, the present invention will be described in detail based on preferred embodiments with appropriate reference to the drawings.

In a “prediction method for the durability of a tire” (hereinafter referred to as prediction method) according to one embodiment of the present invention, the durability of a tire is predicted on the basis of findings obtained by actually causing the tire to run.

In the present invention, the tire used to obtain the above-described findings is referred to as reference tire Tr (or tire Tr). The tire for which prediction is to be performed is also referred to as target tire Tt (or Tire Tt).

The tires targeted by the prediction method are preferably tires for a passenger car and tires for a small truck.

### Test Apparatus

A test apparatus 2 used in the prediction method will be described.

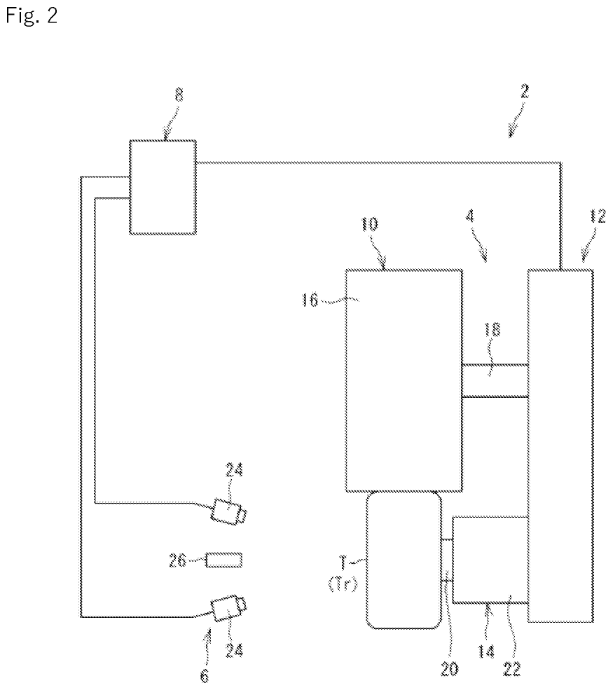

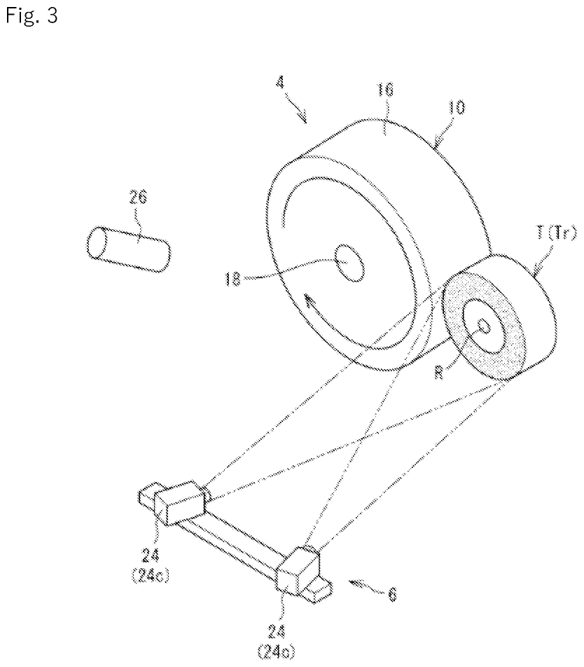

FIGS. 2 and 3 show the test apparatus 2 used in the prediction method. FIG. 2 is a plan view of the test apparatus 2. FIG. 3 is a perspective view of the test apparatus 2. FIGS. 2 and 3 show an outline of the test apparatus 2.

The test apparatus 2 performs a running test of a tire T. The test apparatus 2 measures the actual shape of the running tire T. The tire T set on the test apparatus 2 shown in FIGS. 2 and 3 is the reference tire Tr.

The test apparatus 2 includes a running part 4, a measurement part 6, and a control part 8.

The running part 4 performs running of the reference tire Tr. The running part 4 includes a drum 10, a drive unit 12, and a ground-contact unit 14.

The drum 10 has a road surface 16 and a center shaft 18. The road surface 16 is a portion on which the tire Tr rolls. In the test apparatus 2, the outer circumferential surface of the drum 10 is the road surface 16. The center shaft 18 supports the drum 10. As the center shaft 18 rotates, the drum 10 rotates. As the drum 10 rotates, the tire Tr rolls on the road surface 16.

The drive unit 12 rotationally drives the drum 10. The drive unit 12 rotatably supports the center shaft 18 of the drum 10. Although not shown, the drive unit 12 includes a motor. The motor rotationally drives the center shaft 18 of the drum 10. By controlling the rotation speed of the motor, the rotation speed of the drum 10 is adjusted. Accordingly, the speed of the tire Tr rolling on the road surface 16 is adjusted.

The ground-contact unit 14 supports the tire Tr. The ground-contact unit 14 can move the tire Tr toward the road surface 16 of the drum 10 and bring the tire Tr into contact with the road surface 16. Accordingly, a load is applied to the tire Tr. A state where a load is applied to the tire Tr is also referred to as loaded state. The ground-contact unit 14 can also separate the tire Tr that has been in contact with the road surface 16, from the road surface 16. Accordingly, the load applied to the tire Tr is eliminated. A state where no load is applied to the tire Tr is also referred to as unloaded state.

The ground-contact unit 14 includes a tire shaft 20 and a support portion 22.

One end of the tire shaft 20 is supported by the support portion 22. The tire shaft 20 is supported such that the axis thereof is parallel to the axis of the center shaft 18 of the drum 10. The tire Tr fitted on a rim R is rotatably attached to the other end of the tire shaft 20. The tire Tr is set on the running part 4 such that the axis of the tire Tr is located in a virtual plane including the axis of the drum 10.

The support portion 22 supports the tire shaft 20. The support portion 22 has a moving mechanism (not shown) that can move the tire shaft 20 in the radial direction of the drum 10.

By the support portion 22 moving the tire shaft 20 closer to the drum 10, the tire Tr is pressed against the road surface 16. Accordingly, the tire Tr is brought into a loaded state. By controlling the amount of movement of the tire shaft 20, the magnitude of the load applied to the tire Tr is adjusted.

By the support portion 22 moving the tire shaft 20 away from the drum 10, the tire Tr is separated from the road surface 16. Accordingly, the tire Tr is brought into an unloaded state.

The support portion 22 has an angle adjustment mechanism (not shown). The angle adjustment mechanism can adjust the angle of the tire shaft 20 with respect to the center shaft 18 of the drum 10. Although not described in detail, the running part 4 can adjust the slip angle and the camber angle of the tire Tr by tilting the tire shaft 20 with respect to the center shaft 18 of the drum 10.

The measurement part 6 measures the actual shape of the tire Tr. The measurement part 6 includes a measurement means 24 for measuring the actual shape of the tire Tr. The measurement means 24 of the test apparatus 2 is two cameras 24c. The two cameras 24c are used in combination with a stroboscope 26, and images of the outer surface of the tire Tr are captured by a stereo method. By analyzing the captured images, information representing the actual shape of the tire Tr is obtained.

In the test apparatus 2, the measurement means 24 is not particularly limited, as long as the actual shape of the tire Tr can be measured. In the test apparatus 2, as the measurement means 24, a displacement sensor may be used, or a high-sensitivity camera may be used.

The control part 8 is connected to each of the running part 4 and the measurement part 6 by a communication cable. The control part 8 is composed of, for example, a programmable sequencer, a microcomputer, a personal computer, or another control device. The control part 8 controls the operation of the running part 4 and the measurement part 6.

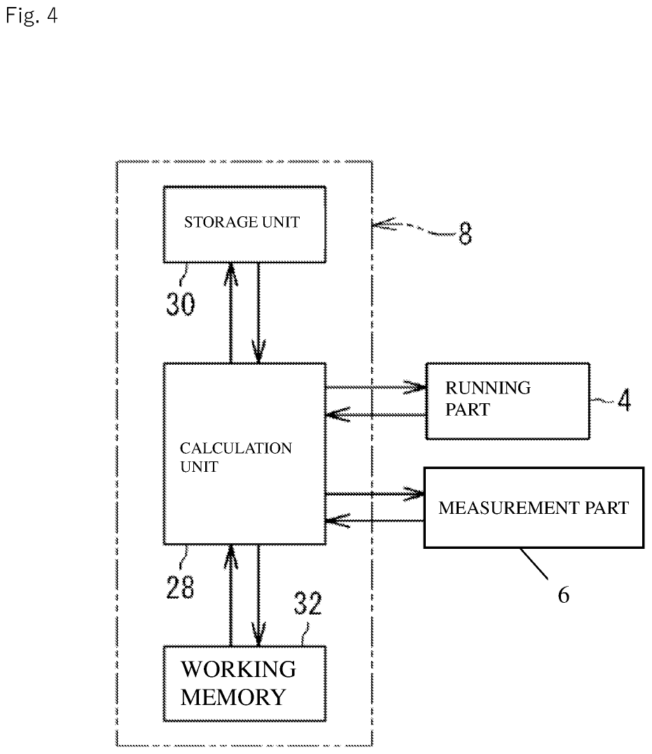

FIG. 4 is a conceptual diagram showing an example of the control part 8. The control part 8 is configured to include a calculation unit 28 composed of a central processing unit (CPU), a storage unit 30 which stores processing procedures, and a working memory 32 which reads the processing procedures from the storage unit 30. The control part 8 may be provided with a display unit for displaying processing results, etc., and an operation unit to be operated by an operator.

### Prediction Method for Durability of Tire

Next, the prediction method according to the one embodiment of the present invention will be described with the case where the prediction method is executed using the above-described test apparatus 2, as an example. This prediction method is a method for predicting the durability of a tire in consideration of a standing wave phenomenon.

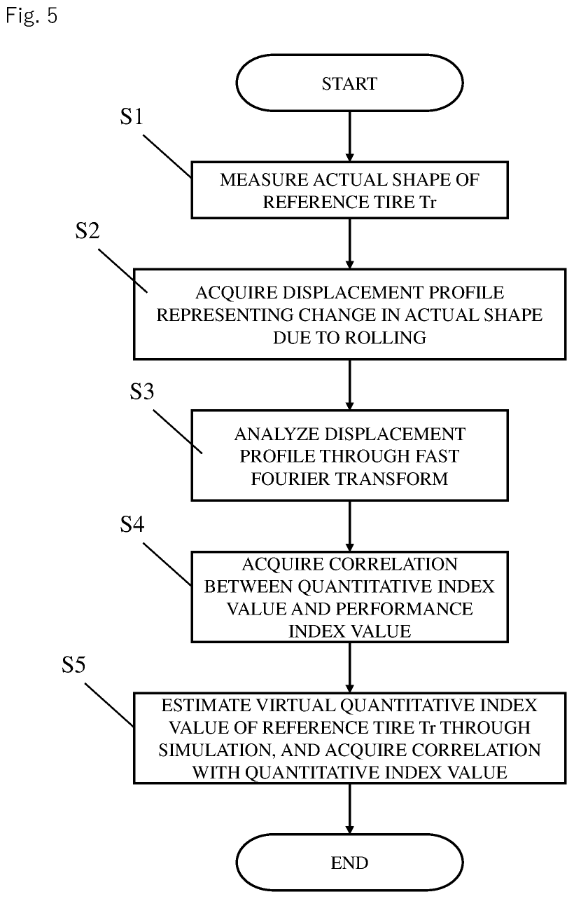

FIG. 5 shows an example of the flow of the prediction method. The prediction method includes
(1) a step S1 of measuring the actual shape of the reference tire Tr,
(2) a step S2 of acquiring a displacement profile representing a change in the actual shape due to rolling,
(3) a step S3 of analyzing the displacement profile through fast Fourier transform,
(4) a step S4 of acquiring a correlation between a quantitative index value and a performance index value, and
(5) a step S5 of estimating a virtual quantitative index value of the reference tire Tr through simulation and acquiring a correlation between the virtual quantitative index value and the quantitative index value.

### Step S1

In the step S1, the actual shape of the reference tire Tr rolling on a road surface is measured. For the measurement of the actual shape, the reference tire Tr is set on the test apparatus 2.

The tire Tr is fitted on the rim R. The rim R may be, for example, a standardized rim, or an acceptable rim in the JATMA standard. The rim R may be a test rim corresponding to an applicable rim in the JATMA standard.

After the tire Tr is fitted on the rim R, the interior of the tire Tr is filled with air. Accordingly, the internal pressure of the tire Tr is adjusted. The internal pressure of the tire T may be adjusted to a standardized internal pressure, may be adjusted to an internal pressure lower than the standardized internal pressure, or may be adjusted to an internal pressure higher than the standardized internal pressure.

After the internal pressure is adjusted, the rim R on which the tire Tr has been fitted is attached to the tire shaft 20 of the running part 4. A load is applied to the tire Tr by pressing the tire Tr against the road surface 16. The load applied to the tire Tr may be a standardized load, may be a load lower than the standardized load, or may be a load higher than the standardized load.

In the prediction method, conditions such as internal pressure, load, slip angle, and camber angle are set in consideration of a running state of the target tire Tt for which prediction is to be performed.

After the setting of the tire Tr on the test apparatus 2 is completed, the control part 8 drives the drive unit 12 of the running part 4 to rotate the drum 10. Accordingly, running of the tire Tr is started. The control part 8 controls the speed of the tire Tr, while monitoring the load applied to the tire Tr, according to a speed profile recorded in the storage unit 30.

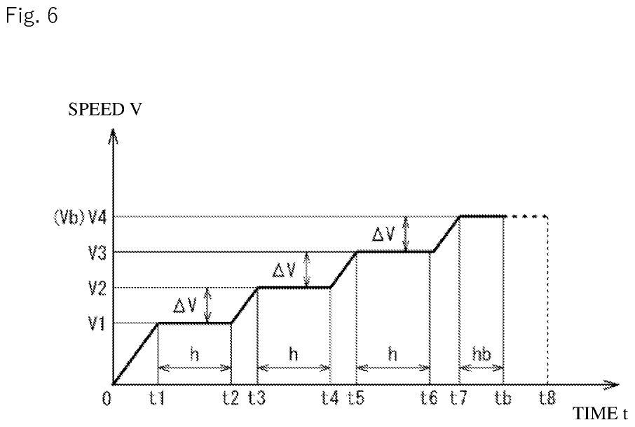

FIG. 6 is a graph illustrating a speed profile of the tire Tr executed in the running test. In the graph, the horizontal axis represents a time t, and the vertical axis represents a speed V. The speed profile shown in FIG. 6 is an example of the speed profile executed in the running test of step S1.

In the prediction method, in step S1, the test apparatus 2 increases the speed V of the tire Tr stepwise. Reference characters V1 to V4 shown on the vertical axis in FIG. 6 represent set speeds in respective steps. When running of the tire Tr is started, the test apparatus 2 increases the speed V to the set speed V1. When the speed V reaches the set speed V1 at time t1, the test apparatus 2 holds the speed V at the set speed V1 until time t2. When the time t reaches time t2, the test apparatus 2 increases the speed V to the set speed V2. When the speed V reaches the set speed V2 at time t3, the test apparatus 2 holds the speed V at the set speed V2 until time t4.

In the prediction method, in step S1, the speed V of the tire Tr is increased stepwise by repeating multiple times a step of setting the speed V of the tire Tr to a predetermined speed and causing the tire Tr to run at that speed for a predetermined time. This step is repeated until the running of the tire Tr can no longer be maintained, for example, due to a burst of the tire Tr or the like. The set speed V1 in the first step is set to a speed obtained by subtracting 100 km/h from the highest speed represented by the speed symbol of the tire Tr. Furthermore, the time required to shift from one step to the next step is set within 1 minute.

In FIG. 6, each time range indicated by a double-headed arrow h is a time for which the tire Tr runs at the set speed in one step (hereinafter referred to as running time h). Each speed range indicated by a double-headed arrow ΔV is the difference between the set speed of the tire Tr in a step next to one step and the set speed of the tire Tr in the one step (hereinafter referred to as speed increment ΔV).

In FIG. 6, a time indicated by reference character tb is a time at which the tire Tr bursts and the running of the tire Tr can no longer be maintained. A time range indicated by a double-headed arrow hb is a time for which the tire Tr runs at the speed V4.

If the running time until the tire Tr is destroyed does not include the time required for the speed V to reach the next set speed (e.g., the time required to increase the speed V from the set speed V1 to the set speed V2), then if the speed profile shown in FIG. 6 is the result of the running test of the tire Tr, the running time until the tire Tr is destroyed is represented as the sum (3 h+hb) of the running time h at the set speed V1, the running time h at the set speed V2, the running time h at the set speed V3, and the running time hb at the set speed V4. That is, as for the result of the running test, the speed V at which the tire Tr is destroyed is represented as the set speed V4, and the running time until the tire Tr is destroyed is represented as 3 h+hb.

In the present invention, the speed at which the tire is destroyed and the running time until the tire is destroyed, which are obtained by the running test, are performance index values representing the durability of the tire.

In the prediction method, the performance index values are stored in the control part 8.

In the step S1, the actual shape of the tire Tr is measured. As described above, the two cameras 24c as the measurement means 24 are used in combination with the stroboscope 26, and images of the outer surface of the tire Tr are captured by a stereo method. By analyzing the captured images, information representing the actual shape of the tire Tr is obtained. The analysis of the captured images is performed, for example, in the control part 8. The information representing the actual shape of the tire Tr and obtained by the analysis is stored, for example, in the control part 8.

In step S1, in order to measure the actual shape of the tire Tr, paint is applied to the outer surface of the tire Tr by a spray or the like to create a plurality of spray points made of the paint, in advance. By recognizing the spray points as coordinate points in the captured images and analyzing the images, information of the outer surface shape in a three-dimensional coordinate system over the entire circumference of the tire is obtained. In the obtained outer surface shape in the three-dimensional coordinate system, for example, measurement points are extracted at an arbitrary position and connected together, thereby obtaining an actual shape over one tire circumference at that position. An actual shape over one tire circumference may be represented by connecting positional information about one rotation at a specific position.

As described above, after the internal pressure is adjusted, the rim R on which the tire Tr has been fitted is attached to the tire shaft 20 of the running part 4. Then, a load is applied to the tire Tr by pressing the tire Tr against the road surface 16.

In step S1, the actual shape of the tire Tr is measured before the tire Tr is pressed against the road surface 16. In the present invention, the actual shape measured before the tire Tr is pressed against the road surface 16 is the actual shape of the stopped tire Tr. Then, in each step of the running test, the actual shape of the tire Tr is measured. In the present invention, the actual shape measured in the running test is the actual shape of the rolling tire Tr.

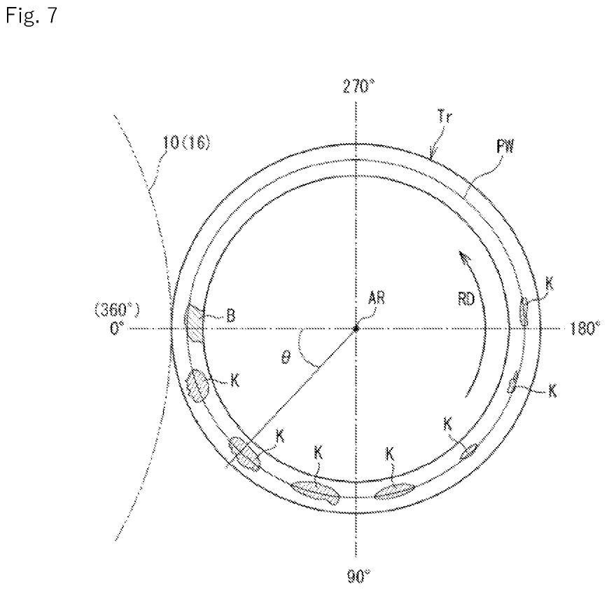

FIG. 7 shows an example of measurement results of the actual shape of the tire Tr in a step in which a standing wave phenomenon occurs. A position indicated by reference character AR is the axis of a rotation shaft of the tire Tr. The axis AR coincides with the axis of the tire shaft 20 in the test apparatus 2. The actual shape shown in FIG. 7 is the shape of a side surface of the tire Tr rotating about the axis AR in a direction indicated by an arrow RD.

In FIG. 7, a position indicated by 0 (zero) degrees is defined as a reference position, and the position of each tire portion is represented by an angle θ. For example, a position at which the angle θ is 90 degrees is referred to as phase 90 degrees. A portion from a position at which the angle θ is 30 degrees to a position at which the angle θ is 60 degrees is also referred to as range from phase 30 degrees to phase 60 degrees.

In FIG. 7, a portion indicated by reference character B is a portion detected as a bulge. Each portion indicated by reference character K is a portion detected as a depression.

The bulge B is observed at the reference position, that is, a portion that is in contact with the road surface 16. At this portion, the tire Tr is pressed against the road surface 16. The side portion of the tire Tr is deformed so as to protrude outward, so that this portion is detected as the bulge B.

In a range from phase 15 degrees to phase 180 degrees, the depressions K scattered in the circumferential direction are observed. As described above, the tire Tis deformed into a wavy shape when a standing wave phenomenon occurs. As shown in FIG. 1, the wavy deformation appears after the tire T is separated from the road surface. In FIG. 7, the range from phase 15 degrees to phase 180 degrees corresponds to a portion after the tire Tr is separated from the road surface 16. The depressions K scattered in the circumferential direction and observed in the range from phase 15 degrees to phase 180 degrees are a sign of the standing wave phenomenon.

In the prediction method, a plurality of tires Tr having the same specifications are prepared. For example, the internal pressures of the respective tires Tr are adjusted to different internal pressures. In this case, a plurality of reference tires Tr having different internal pressures are prepared. The running test is performed on each tire Tr. Then, in each step of the running test, the actual shape of the rolling tire Tr is measured as shown in FIG. 7.

In the prediction method, a plurality of reference tires Tr having the same internal pressure may be prepared, the running test may be performed on each tire Tr with a load applied to the tire Tr being changed, and the actual shape of the rolling tire Tr may be measured in each step of the running test. A plurality of reference tires Tr having the same internal pressure may be prepared, the running test may be performed on each tire Tr with a camber angle being changed, and the actual shape of the rolling tire Tr may be measured in each step of the running test. A plurality of reference tires Tr having the same internal pressure may be prepared, the running test may be performed on each tire Tr with a slip angle being changed, and the actual shape of the rolling tire Tr may be measured in each step of the running test. The running conditions of the tires Tr are determined as appropriate in consideration of the running state of the tire whose durability is to be predicted.

### Step S2

In step S2, a displacement profile representing a change in the actual shape of the tire Tr due to rolling is acquired. In step S2, a displacement profile represented by the difference between the actual shape of the rolling tire Tr and the actual shape of the stopped tire Tr as a change in the actual shape of the tire Tr due to rolling is acquired. This acquisition of the displacement profile is performed, for example, in the control part 8.

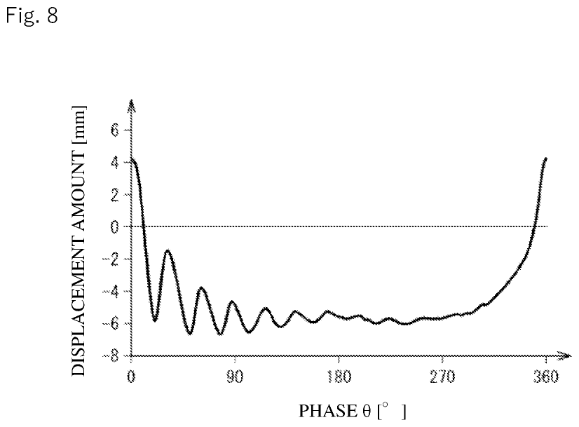

FIG. 8 is a graph showing an example of the displacement profile acquired in step S2. In the graph, the horizontal axis represents the phase of the tire Tr, and the vertical axis represents a displacement amount. This displacement profile represents a change in the actual shape of the tire caused by the tire rolling on the road surface.

The tire size of the tire for which the displacement profile in FIG. 8 is acquired is 205/65R16 95H, and the running conditions for the step in which this displacement profile is acquired are as follows.
Rim size: 16×6.0
Internal pressure: 280 kPa
Camber angle: 0 degrees
Slip angle: 0 degrees
Load: 80% of standardized load
Speed: 210 km/h

As described above, in step S1, the actual shape of the stopped tire Tr and the actual shape of the rolling tire Tr are measured. This displacement profile is acquired by calculating the difference between the actual shape of the rolling tire Tr and the actual shape of the stopped tire Tr. A position at which the displacement amount is 0 (zero) mm corresponds to the actual shape of the stopped tire Tr.

In step S1 described above, the actual shape of the tire Tr, for example, as shown in FIG. 7 is measured. In step S2, information regarding the actual shape over one tire circumference at a specific position is extracted from the information regarding the actual shape of the tire Tr acquired by the measurement, in order to acquire a displacement profile, for example, as shown in FIG. 8.

In FIG. 7, a position indicated by reference character PW corresponds to a position at which the tire Tr has a maximum width in the standardized state. FIG. 8 shows a displacement profile acquired on the basis of the actual shape over one tire circumference at the maximum width position PW of the tire Tr.

As shown in FIG. 8, the bulge B at the phase 0 degrees position and the depressions K scattered in the range from phase 15 degrees to phase 180 degrees, which are shown in FIG. 7, are reflected in the displacement profile. With the prediction method, a sign of the standing wave phenomenon can be captured by acquiring the deformation of the tire T due to running as a displacement profile.

A position at which the range of variation in the tire axial direction due to rolling at the side portion of the tire is large is the maximum width position of the tire. Therefore, in this embodiment, the actual shape over one tire circumference at the maximum width position PW of the tire Tr is extracted in order to acquire a displacement profile. However, in the prediction method, the actual shape used for acquiring a displacement profile is not limited to the actual shape over one tire circumference at the maximum width position PW of the tire Tr. The actual shape over one tire circumference at a bead portion of the tire Tr may be used, or the actual shape over one tire circumference at a buttress of the tire Tr may be used. The extraction position of the information regarding the actual shape used for acquiring a displacement profile is selected in consideration of the location of damage that affects the durability of the tire for which prediction is to be performed, etc.

As described above, in step S1, a plurality of reference tires Tr having different internal pressures are prepared. On each tire Tr, step S2 is executed to acquire a displacement profile representing a change in the actual shape of the tire Tr due to rolling.

### Step S3

In step S3, the displacement profile acquired in step S2 is analyzed through fast Fourier transform. In step S3, displacement amounts of order components of the first order to the Nth order (N is an integer of 2 or more) of the displacement profile is calculated through fast Fourier transform. This analysis of the displacement profile is performed, for example, in the control part 8.

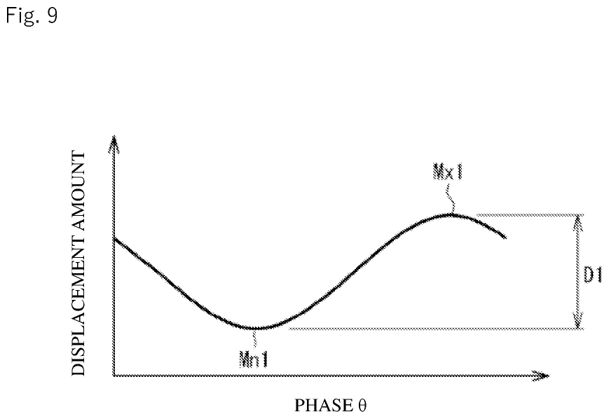

FIG. 9 shows an image of a displacement profile of the order component of the first order (hereinafter referred to as first-order component) acquired by performing fast Fourier transform on the displacement profile. In FIG. 9, reference character Mx1 indicates the maximum value of the first-order component, and reference character Mn1 indicates the minimum value of the first-order component. A length indicated by a double-headed arrow D1 is the displacement amount of the first-order component. The displacement amount DI is represented as the difference between the maximum value Mx1 and the minimum value Mn1.

In the present invention, the displacement amount of each order component means the range of displacement represented as the difference between the maximum value and the minimum value of each order component, acquired by performing fast Fourier transform on the displacement profile.

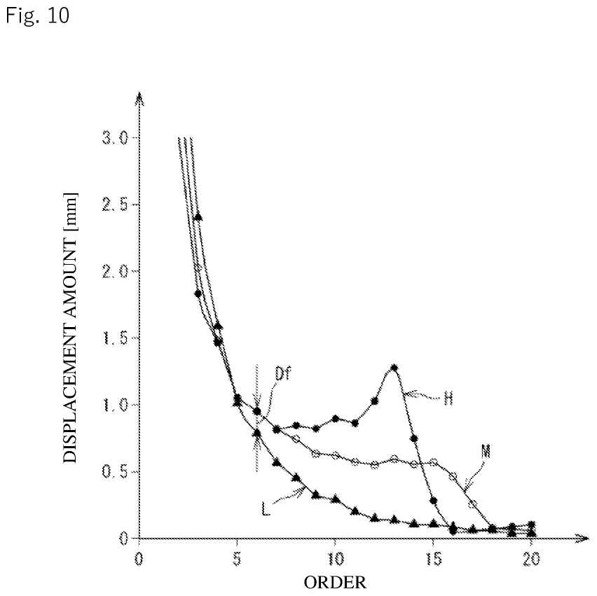

FIG. 10 is a graph showing the displacement amount of each order component acquired by performing fast Fourier transform on the displacement profile. In the graph, the horizontal axis represents the order, and the vertical axis represents the displacement amount.

As described above, in step S1, the actual shape of the tire Tr is measured while the speed V of the tire Tr is increased stepwise. FIG. 10 shows the analysis results of three displacement profiles having different speeds when the actual shape is measured, as an example of the results of analysis through fast Fourier transform on the displacement profile.

In order to acquire the analysis results shown in FIG. 10, displacement profiles of the actual shape measured, while the speed is increased stepwise, for a tire (tire size: 205/65R1695H) adjusted to a state shown below are used.
Rim size: 16×6.0
Internal pressure: 280 kPa
Camber angle: 0 degrees
Slip angle: 0 degrees
Load: 80% of standardized load

In FIG. 10, the analysis result indicated by reference character L is an analysis result based on the actual shape measured at the lowest speed (110 km/h) among the three analysis results. The analysis result indicated by reference character H is an analysis result based on the actual shape measured at the highest speed (210 km/h) among the three analysis results. The analysis result indicated by reference character M is an analysis result based on the actual shape measured at a speed (190 km/h) higher than the speed of the analysis result L and lower than the speed of the analysis result H.

As shown in FIG. 10, the analysis result L, which is the analysis result of the displacement profile at the lowest speed, shows a tendency that the displacement amount monotonically decreases as the order increases. In the analysis result M which is the analysis result of the displacement profile at the second highest speed, an increase in the displacement amount, which is not observed in the analysis result L, is observed at the fifth and subsequent order components. In the analysis result H which is the analysis result of the displacement profile at the highest speed, an increase in the displacement amount is observed at the fifth and subsequent order components as in the analysis result M, and a peak of the displacement amount is recognized at the 13th-order component.

As the speed of the tire increases, a sign of the standing wave phenomenon soon appears in the tire. The tire is deformed into a wavy shape, and the higher the speed of the tire is, the greater the deformation of the tire is.

In the measurement of the actual shape, no sign of the standing wave phenomenon is observed in the step in which the analysis result Lis acquired, but wavy deformation that is a sign of the standing wave phenomenon is observed in the step in which the analysis result M is acquired. In the step in which the analysis result H is acquired, wavy deformation due to the sign of the standing wave phenomenon is observed to be more strongly represented than in the step in which the analysis result M is acquired.

That is, the analysis results shown in FIG. 10 indicates that a sign of the standing wave phenomenon can be captured by acquiring the deformation of the tire due to running as a displacement profile and analyzing this displacement profile through fast Fourier transform, and this sign can be grasped as a displacement amount.

Meanwhile, when the analysis results M and H in which the sign of the standing wave phenomenon is observed are compared with the analysis result L in which no sign of the standing wave phenomenon is observed in FIG. 10, it is confirmed that a difference occurs in the displacement amount therebetween at the fifth and subsequent order components. In FIG. 10, a length indicated by two arrows Df represents the length of the deviation from the analysis result in which no sign of the standing wave phenomenon is observed (the analysis result L in FIG. 10).

In the present invention, if the deviation length Df at the lowest order component (hereinafter referred to as reference order component) among the order components at which a deviation from the analysis result in which no sign of the standing wave phenomenon is observed is confirmed is 0.2 mm or more, the displacement amounts at the order component whose order is smaller than the order of the reference order component by one and at the subsequent order components are each treated as a displacement amount in which displacement due to a sign of the standing wave phenomenon is reflected. If the deviation length Df at the reference order component is less than 0.2 mm, the displacement amount at the order component whose order is smaller by one than the order of the order component at which the deviation length Df is 0.2 mm or more on the higher order side with respect to the reference order component and at the subsequent order components is treated as a displacement amount in which displacement due to a sign of the standing wave phenomenon is reflected.

In the analysis result M or H shown in FIG. 10, the deviation from the analysis result L is observed at the 6th and subsequent order components, and the deviation length Df at this 6th-order component is 0.2 mm or more. Therefore, the displacement amounts at the 5th-order component which is the order component whose order is smaller by one than that of the 6th-order component, which is the reference order component, and at the subsequent order components are each treated as a displacement amount in which displacement due to a sign of the standing wave phenomenon is reflected. It is preferable that whether the displacement amount at the order component is a displacement amount in which displacement due to a sign of the standing wave phenomenon is reflected, is checked in a tire whose internal pressure is adjusted to 1.1 times or more the standardized internal pressure.

Although not described in detail, it is confirmed that in an analysis result in which a peak of the displacement amount is observed as in the analysis result H, an increase in the displacement amount is observed at the order component whose order is twice the order component at which the peak of the displacement amount is observed. In consideration of this point, in step S3, up to the order components whose orders are twice the order component at which the peak of the displacement amount is observed are order components which are targets for which the displacement amount is calculated.

As shown in FIG. 10, the analysis results M and H converge at the 18th and subsequent orders to the analysis result L in which no sign of the standing wave phenomenon is observed. With reference to the results shown in FIG. 10, in description regarding the subsequent analysis results, unless otherwise mentioned, the displacement amount in an order range of 5th order or higher and 20th order or lower is treated as a displacement amount in which a change in the actual shape due to a sign of the standing wave phenomenon is reflected.

As described above, in the prediction method, step S2 is executed on each of the plurality of reference tires Tr prepared in step S1, and a displacement profile representing a change in the actual shape of the tire Tr due to rolling is acquired. In the prediction method, step S3 is executed on the displacement profile acquired in step S2, and a displacement amount of each order component constituting the displacement profile is calculated. Then, the next step S4 is executed using a part of the displacement profile for which the displacement amount is calculated.

### Step S4

In step S4, a correlation between a quantitative index value and a performance index value is acquired. Specifically, in step S4, the reciprocal of the sum of the displacement amounts of order components in which a change in the actual shape due to a sign of the standing wave phenomenon is reflected is obtained as a quantitative index value, and a correlation between a performance index value representing the durability of the tire Tr and the quantitative index value is acquired. The calculation of the quantitative index value and the acquisition of the correlation between the performance index value and the quantitative index value are performed, for example, in the control part 8. In the acquisition of the correlation between the performance index value and the quantitative index value, a quantitative index value calculated in the control part 8 and a performance index value stored in the control part 8 are used.

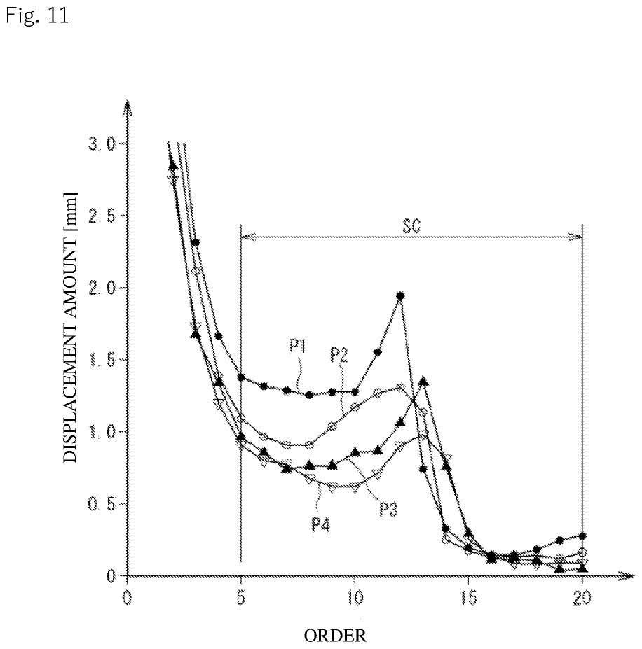

FIG. 11 shows the calculation results of the displacement amount of each order component constituting the displacement profile of the actual shape of each of four reference tires Tr having different internal pressures. FIG. 11 is a graph showing the displacement amount of each order component acquired by performing fast Fourier transform on each displacement profile. In the graph, the horizontal axis represents the order, and the vertical axis represents the displacement amount. A range indicated by a double-headed arrow SC is a range where the displacement amount is treated as a displacement amount in which a change in the actual shape due to a sign of the standing wave phenomenon is reflected in the analysis results shown in FIG. 11.

FIG. 11 shows four analysis results, among which the analysis result indicated by reference character Pl is an analysis result based on the actual shape of the tire Tr having an internal pressure adjusted to the lowest pressure (220 kPa). The analysis result indicated by reference character P2 is an analysis result based on the actual shape of the tire Tr having an internal pressure (250 kPa) higher than the internal pressure of the tire Tr for the analysis result P1. The analysis result indicated by reference character P3 is an analysis result based on the actual shape of the tire Tr having an internal pressure (280 kPa) higher than the internal pressure of the tire Tr for the analysis result P2. The analysis result indicated by reference character P4 is an analysis result based on the actual shape of the tire Tr having an internal pressure (310 kPa) higher than the internal pressure of the tire Tr for the analysis result P3, in other words, having a highest internal pressure.

In order to acquire the analysis results shown in FIG. 11, displacement profiles of the actual shape measured, while the speed is increased stepwise, for a tire (tire size: 205/65R16 95H) adjusted to a state shown below, except for the internal pressure, are used. The analysis results shown in FIG. 11 are the analysis results of displacement profiles acquired in the steps in which the speed represented by the speed symbol of the tire Tr (in this case, H) is set to the set speeds.
Rim size: 16×6.0
Camber angle: 0 degrees
Slip angle: 0 degrees
Load: 80% of standardized load

In step S4, the sum of the displacement amounts of the order components in which a change in the actual shape due to the standing wave phenomenon is reflected is obtained in order to acquire a quantitative index value. Table 1 below shows each sum of displacement amounts obtained from the four analysis results shown in FIG. 11, along with the running time until the tire Tr is destroyed, as a performance index value representing the durability of the tire Tr, as confirmed in step S1. The sums of the displacement amounts shown in Table 1 are each the sum of the displacement amounts of the respective order components included in the order range indicated by the double-headed arrow SC in FIG. 11, that is, in the order range of 5th order or higher and 20th order or lower.

TABLE 1

| | Internal pressure | Sum | Running time |
|---|---|---|---|
| Analysis result | [kPa] | [mm] | [min] |
| P1 | 220 | 13.52 | 123.0 |
| P2 | 250 | 10.90 | 128.5 |
| P3 | 280 | 9.68 | 137.0 |
| P4 | 310 | 8.53 | 142.5 |

As described above, in step S4, a quantitative index value represented as the reciprocal of each sum of displacement amounts is obtained, and a correlation between the quantitative index value and the performance index value is acquired.

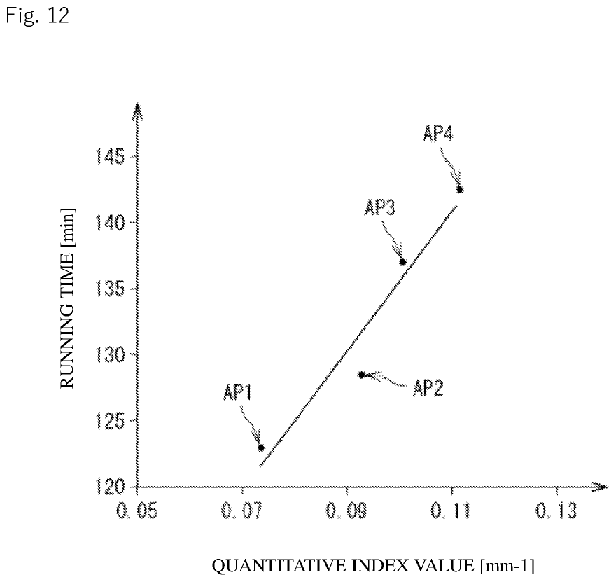

FIG. 12 is a graph showing the correlation between the quantitative index value and the performance index value gasped by each sum of displacement amounts and each running time shown in Table 1 above. In the graph, the horizontal axis represents the quantitative index value, and the vertical axis represents the running time as the performance index value.

A point indicated by reference character AP1 shows the relationship between the quantitative index value and the performance index value based on the analysis result P1. A point indicated by reference character AP2 shows the relationship between the quantitative index value and the performance index value based on the analysis result P2. A point indicated by reference character AP3 shows the relationship between the quantitative index value and the performance index value based on the analysis result P3. A point indicated by reference character AP4 shows the relationship between the quantitative index value and the performance index value based on the analysis result P4.

As shown in FIG. 12, the correlation between the quantitative index value and the performance index value can be approximated by a linear function. This indicates that the quantitative index value based on the displacement amounts acquired by analyzing the displacement profile through fast Fourier transform in step S3 is correlated with the performance index value. Therefore, if the quantitative index value of the target tire Tt for which prediction of durability is to be performed can be grasped, the performance index value of the target tire Tt can be grasped by using the correlation shown in FIG. 12.

In the present invention, the relational expression representing the correlation between the quantitative index value and the performance index value is obtained by a least squares method. The correlation between these values is represented by a relational expression having a correlation coefficient close to 1. A relational expression representing a correlation between the virtual quantitative index value and the performance index value and a relational expression representing a correlation between the virtual quantitative index value and the quantitative index value, which will be described later, are also obtained similarly.

### Step S5

In step S5, the virtual quantitative index value of the reference tire Tr is estimated through simulation, and a correlation between the virtual quantitative index value and the quantitative index value is acquired. That is, in step S5, a virtual quantitative index value corresponding to the quantitative index value acquired in step S4 is estimated by simulating rolling of the tire Tr, and a correlation between the virtual quantitative index value and the quantitative index value is acquired.

Although not described in detail, strain generated in a tire due to rolling on a road surface can be calculated, for example, by a finite element method (FEM). Therefore, the present inventors have attempted the processes shown in steps S3 and S4 described above, by calculating a strain profile over one tire circumference generated at the tire maximum width position PW when a tire is caused to roll in the same manner as in the running test executed in step S1, by the FEM, and replacing this strain profile with a displacement profile acquired on the basis of the actual shape over one tire circumference at the maximum width position PW of the tire Tr. The results are shown below.

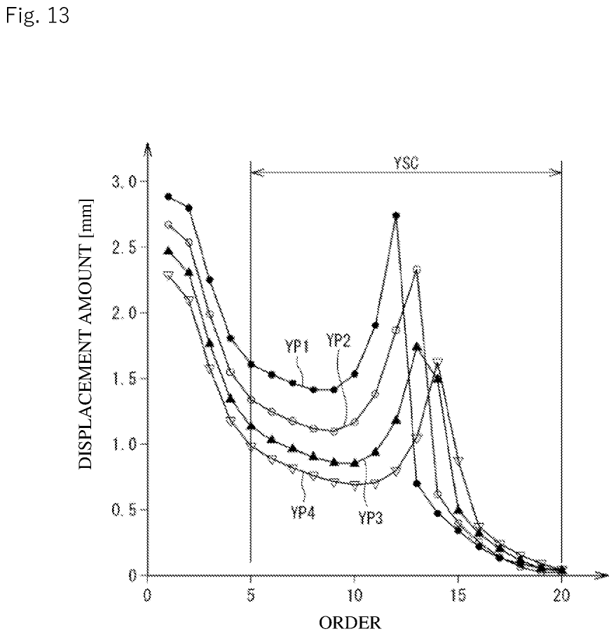

FIG. 13 is a graph showing the displacement amount of each order component acquired by performing fast Fourier transform on each of strain profiles of four reference tires Tr having different internal pressures, acquired by simulating rolling of each tire Tr. In the graph, the horizontal axis represents the order, and the vertical axis represents the displacement amount. The conditions, such as tire size, which are set in order to acquire the strain profiles which are the basis of the analysis results shown in FIG. 13, reflect the contents of the running test performed in order to acquire the analysis results shown in FIG. 11.

FIG. 13 shows four analysis results, among which the analysis result indicated by reference character YP1 is an analysis result with an internal pressure set to a lowest pressure (220 kPa). The analysis result indicated by reference character YP2 is an analysis result with an internal pressure set to an internal pressure (250 kPa) higher than the internal pressure set in order to acquire the analysis result YP1. The analysis result indicated by reference character YP3 is an analysis result with an internal pressure set to an internal pressure (280 kPa) higher than the internal pressure set in order to acquire the analysis result YP2. The analysis result indicated by reference character YP4 is an analysis result with an internal pressure set to an internal pressure (310 kPa) higher than the internal pressure set in order to acquire the analysis result YP3, in other words, to a highest internal pressure.

In step S5, the virtual quantitative index value of the reference tire Tr is estimated through simulation, for example, by performing the process described in step S4 above on the analysis results shown in FIG. 13. Therefore, the sum of the displacement amounts of the order components acquired by performing fast Fourier transform on each strain profile is obtained. The range of order components set in step S4 is used as the target range of order components when the sum of displacement amounts is obtained.

Table 2 below shows each sum of displacement amounts obtained from the four analysis results shown in FIG. 13, along with the running time until the tire Tr is destroyed, as a performance index value representing the durability of the tire Tr, as confirmed in step S1. Each sum of displacement amounts shown in Table 2 is represented as the sum of the displacement amounts of the respective order components included in the order range of 5th order or higher and 20th order or lower (range indicated by a double-headed arrow YSC in FIG. 13), similar to each sum of displacement amounts shown in Table 1.

TABLE 2

| | Internal pressure | Sum | Running time |
|---|---|---|---|
| Analysis result | [kPa] | [mm] | [min] |
| YP1 | 220 | 15.60 | 123.0 |
| YP2 | 250 | 14.17 | 128.5 |
| YP3 | 280 | 12.24 | 137.0 |
| YP4 | 310 | 10.76 | 142.5 |

In step S5, further, a virtual quantitative index value represented as the reciprocal of each sum of displacement amounts is obtained, and a correlation between the virtual quantitative index value and the performance index value is acquired.

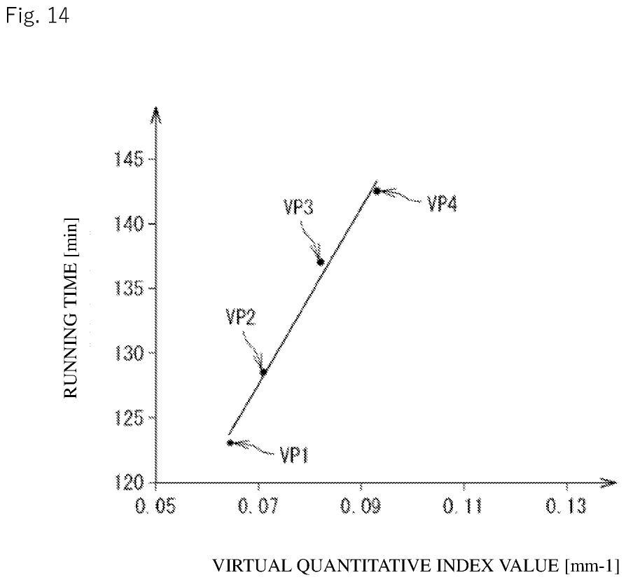

FIG. 14 is a graph showing the correlation between the virtual quantitative index value and the performance index value grasped by each sum of displacement amounts and each running time shown in Table 2 above. In the graph, the horizontal axis represents the virtual quantitative index value, and the vertical axis represents the running time as the performance index value.

A point indicated by reference character VP1 shows the relationship between the virtual quantitative index value and the performance index value based on the analysis result YP1. A point indicated by reference character VP2 shows the relationship between the virtual quantitative index value and the performance index value based on the analysis result YP2. A point indicated by reference character VP3 shows the relationship between the virtual quantitative index value and the performance index value based on the analysis result YP3. A point indicated by reference character VP4 shows the relationship between the virtual quantitative index value and the performance index value based on the analysis result YP4.

As shown in FIG. 14, the correlation between the virtual quantitative index value and the performance index value can be approximated by a linear function, similar to the correlation between the quantitative index value and the performance index value described above. The virtual quantitative index value estimated by simulating rolling of the reference tire Tr is also correlated with the performance index value.

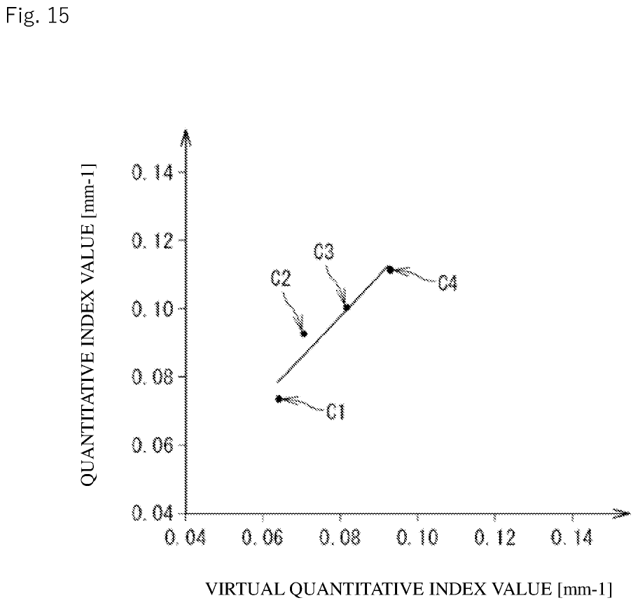

FIG. 15 is a graph showing the correlation between the virtual quantitative index value estimated in step S5 and the quantitative index value obtained in step S4. In the graph, the horizontal axis represents the virtual quantitative index value, and the vertical axis represents the quantitative index value.

A point indicated by reference character C1 shows the relationship between the virtual quantitative index value based on the analysis result YP1 and the quantitative index value based on the analysis result P1. A point indicated by reference character C2 shows the relationship between the virtual quantitative index value based on the analysis result YP2 and the quantitative index value based on the analysis result P2. A point indicated by reference character C3 shows the relationship between the virtual quantitative index value based on the analysis result YP3 and the quantitative index value based on the analysis result P3. A point indicated by reference character C4 shows the relationship between the virtual quantitative index value based on the analysis result YP4 and the quantitative index value based on the analysis result P4.

As shown in FIG. 15, the correlation between the virtual quantitative index value and the quantitative index value can be approximated by a linear function. The virtual quantitative index value estimated by simulating rolling of the reference tire Tr is correlated with the performance index value obtained by an actual running test. This indicates that the displacement amount acquired by performing fast Fourier transform on a displacement profile representing a change in the actual shape of a tire can be estimated by simulating rolling of the tire. In other words, this means that the durability of the target tire Tt for which prediction is to be performed can be predicted without involving destruction by simulating rolling of the target tire Tt to estimate a predicted quantitative index value corresponding to the virtual quantitative index value. That is, by using the prediction method, the speed at which a tire bursts and the running time until the tire bursts can be predicted without involving destruction of the tire. The prediction method allows the durability of a tire for which prediction is to be performed without involving destruction of the tire.

In the prediction method, when the virtual quantitative index value in step S5 or the predicted quantitative index value of the prediction target tire is estimated, the rolling state of the tire is simulated, a method such as steady state transport analysis (SST), which is used in tire rolling analysis, may be used, and a displacement profile for obtaining the virtual quantitative index value or the predicted quantitative index value may be prepared.

As described above, in the speed profile set for the running test performed in step S1, the time for which the tire Tr runs at a set speed in one step, that is, the running time h, is set.

From the viewpoint of being able to accurately predict the durability of a tire, the running time h set in step S1 is preferably not shorter than 30 seconds. From the viewpoint of being able to efficiently predict the durability of a tire, the running time h is preferably not longer than 60 minutes.

In the above-described speed profile, the difference between the set speed of the tire Tr in a step next to one step and the set speed of the tire Tr in the one step, that is, the speed increment ΔV, is set.

From the viewpoint of being able to efficiently predict the durability of a tire, the speed increment ΔV set in step S1 is preferably not less than 5 km/h. From the viewpoint of being able to accurately predict the durability of a tire, the speed increment ΔV is preferably not greater than 10 km/h.

From the viewpoint of being able to efficiently and accurately predict the durability of a tire, it is more preferable that the running time h is not shorter than 30 seconds and not longer than 60 minutes and the speed increment AV is not less than 5 km/h and not greater than 10 km/h.

For example, as shown in FIG. 11, in each of the analysis results used for acquiring the quantitative index value, a peak of the displacement amount is observed in an order range from 10th order to 15th order. As described above, the quantitative index value acquired on the basis of the analysis results in FIG. 11 is correlated with the performance index value. From the viewpoint of being able to improve the prediction accuracy of the durability of a tire, it is preferable that the quantitative index value is obtained in the displacement profile including an order component having a peak in the order components from the 10th to 15th-order components in the relationship between the order component and the displacement amount. In this case, it is more preferable that the quantitative index value is represented as the reciprocal of the sum of displacement amounts of the order components in a range of ±7 order components centered on the order component having a peak.

As described above, the analysis results shown in FIG. 11 are the analysis results of displacement profiles acquired in the steps in which the speed represented by the speed symbol of the tire Tr is set to the set speeds. The quantitative index value acquired on the basis of the analysis results in FIG. 11 is correlated with the performance index value. From the viewpoint of being able to improve the prediction accuracy of the durability of a tire, it is more preferable that step S4 described above is performed using the displacement profiles acquired in the steps in which the speed represented by the speed symbol of the tire Tr is set to the set speeds.

As is obvious from the above description, according to the present invention, a prediction method for the durability of a tire, which allows the durability of a tire for which prediction is to be performed without destroying the tire, is obtained.

The above-described prediction method for the durability of a tire can also be applied to various tires.

What is claimed is:

1. A prediction method for durability of a tire in consideration of a standing wave phenomenon, comprising:
measuring an actual shape of a reference tire rolling on a road surface;
acquiring a displacement profile represented by a difference between the actual shape of the rolling reference tire and an actual shape of the reference tire in a stopped state, as a change in the actual shape due to rolling;
calculating displacement amounts of order components of first to Nth orders (N is an integer of 2 or more) in the displacement profile through fast Fourier transform;
obtaining, as a quantitative index value, a reciprocal of a sum of those of the displacement amounts of order components reflecting a change in the actual shape due to a sign of the standing wave phenomenon, and acquiring a correlation between a performance index value representing durability of the reference tire and the quantitative index value; and
simulating rolling of the reference tire to estimate a virtual quantitative index value corresponding to the quantitative index value, and acquiring a correlation between the virtual quantitative index value and the quantitative index value, wherein
in measuring the actual shape of the reference tire, a speed of the reference tire is increased stepwise by repeating a process of setting the speed of the reference tire to a predetermined speed and causing the reference tire to run for a predetermined time.

2. The prediction method for durability of a tire according to claim 1, wherein
the predetermined time for which the reference tire runs at the set speed in one such step is not shorter than 30 seconds and not longer than 60 minutes, and
a difference between the set speed of the reference tire in one performance of the process and the set speed of the reference tire in a next performance of the process after the one performance of the process is not less than 5 km/h and not greater than 10 km/h.

3. The prediction method for durability of a tire according to claim 1, wherein the process is repeated until the running of the reference tire can no longer be maintained.

4. The prediction method for durability of a tire according to claim 1, wherein the quantitative index value is obtained in a displacement profile including an order component having a peak in order components from 10th to 15th-order components in a relationship between the order component and the displacement amount.

5. The prediction method for durability of a tire according to claim 4, wherein the quantitative index value is represented as a reciprocal of a sum of displacement amounts of order components in a range of ±7 order components centered on the order component having a peak.

6. The prediction method for durability of a tire according to claim 2, wherein the process is repeated until the running of the reference tire can no longer be maintained.

7. The prediction method for durability of a tire according to claim 1, wherein
the measuring of the actual shape of the reference tire rolling on the road surface comprises operating cameras to capture images of the reference tire, and analyzing the captured images to determine the actual shape of the reference tire.

8. The prediction method for durability of a tire according to claim 7, wherein
the analyzing of the captured images comprises recognizing marked points on the reference tire as coordinate points.

9. The prediction method for durability of a tire according to claim 1, wherein
the measuring of the actual shape of the reference tire rolling on the road surface comprises applying a load to the reference tire to press the reference tire against the road surface.

10. The prediction method for durability of a tire according to claim 9, wherein
the stopped state is a state of the reference tire before the reference tire is pressed against the road surface.

11. The prediction method for durability of a tire according to claim 1, wherein
the acquiring of the correlation between the virtual quantitative index value and the quantitative index value includes approximating the correlation by a linear function.
